(19) United States
(12) Patent Application Publication
(10) Pub. No.: US 2023/0301247 A1
(43) Pub. Date: Sep. 28, 2023

(54) MACHINE LEARNING SYSTEMS FOR AUTONOMOUS AND SEMIAUTONOMOUS PLANT GROWTH

(71) Applicant: HYON CHOI, FLUSHING, NY (US)

(72) Inventor: HYON CHOI, FLUSHING, NY (US)

(21) Appl. No.: 18/126,433

(22) Filed: Mar. 25, 2023

Related U.S. Application Data
(60) Provisional application No. 63/323,505, filed on Mar. 25, 2022.

(51) Int. Cl. A01G 9/24; A01G 7/04; H04W 4/38

(52) U.S. Cl. CPC A01G 9/247; A01G 7/045; A01G 9/249; H04W 4/38

(57) ABSTRACT

The invention generally relates to systems for growing plants autonomously or semi-autonomously with no or minimum human intervention. More specifically, the systems herein use machine learning to effect autonomous or semi-autonomous operation thereof for the growth of subject plants.

This nonprovisional patent application claims priority to provisional patent application no. 63/323,505 filed on Aug. 25, 2022 and U.S. Pat. application no. 17/245,486 which was on filed Apr. 30, 2021.

### FIELD OF THE INVENTION

The invention generally relates to systems for growing plants autonomously or semi-autonomously with no or minimum human intervention. More specifically, the systems herein use machine learning to effect autonomous or semi-autonomous operation thereof for the growth of subject plants.

### BACKGROUND OF THE INVENTION

Conventional methods and systems in growing plants include more human intervention in various stages of plant growth like watering, soil maintenance, the addition of nutrients, the timed application of growth-inducing light (e.g., natural and unnatural), and the like. Modern growing systems involve many more efforts and time in taking care of the plants. These systems cannot cater to the needs of the growing population.

Autonomous or nearly autonomous (i.e., semi-autonomous) systems of plant growth and plant maintenance have gained increased use and importance given skyrocketing increases in the Earth’s human population (i.e., eight billion and counting), trade concerns for both food and pharmaceuticals, human labor costs and more.

Therefore, there is a real world need for alternatives to the conventional plant growing processes. Autonomous and semi-autonomous systems are required to handle various stages of plant growth.

### SUMMARY OF THE INVENTION

Accordingly, the invention provides a system for plant growth, comprising a plant growing area which can be either small or large and can consist of a small greenhouse or a large farm. Within the system is a plant watering device or multiple thereof that make a plant watering system that is positioned about the plant growing area for watering plants located therein.

The system provides critical functions for plant growth including autonomous watering, autonomous climate control, autonomous or semi-autonomous plant feeding, autonomous or semi-autonomous plant nutrient distribution, autonomous or semi-autonomous pest control, and autonomous or semi-autonomous control of lighting, whether natural, artificial or some combination of all of the foregoing.

In addition to all of the above critical functions, the system also autonomously or semi-autonomously monitors plant growth at every stage of plant life within the plant growing area. The system performs this function by use of a myriad of sensors placed within and about the plant growing area.

Multiple sensors for monitoring plant growth within the plant growing area are provided. Sensors within and about the plant growing area monitor water levels, water temperature, air temperature, humidity, soil pH levels, soil nutrient levels in parts per million (i.e., PPM), light use, light intensity, camera usage, carbon dioxide (CO²) levels, nitrogen levels and more. Persons of skill in the art will readily recognize all of the various criteria by which plant growth and maintenance can be monitored, measured and tracked and that such criteria, in and of itself, do not serve as a limitation upon any of the inventive embodiments provided herein.

The system further comprises a climate control system positioned about the plant growing area, a lighting system positioned about the plant growing area, a controller that monitors and controls all attached equipment, and a computer grade server.

In practice, the controller monitors, tracks and executes all of the actions within the system and comprises one or more algorithms to perform its functions. To operate either autonomously or semi-autonomously, the system uses machine learning in the form of one or more algorithms that have the steps of forming a data set; producing an estimate about a pattern in the data set; making a prediction about the data set; evaluating the prediction; optimizing the prediction; and sending instructions to the system for execution of the prediction which is now convertible into a system command depending upon user preference.

The system further includes a personal wireless device having a graphical device for use by a plant grower (e.g., farmer) wherein the plant grower communicates with the system to grow, monitor and track plants within the system. The personal wireless device is in operative communication with the controller.

The system herein provides a user interface placed upon the mobile device by which a user (i.e., plant grower) may interact with and give commands to the system. The user interfaces are configured to allow users to review results of data for a selected sensor or detector, pinpoint relevant portions of data items where the selected sensor or detector is determined to be present, review and retrain detectors or sensors, specify example data items for training detectors or sensors, provide search result feedback, review data monitoring results and analytics, and the like.

The features and advantages described in the specification are not all inclusive and, in particular, many additional features and advantages will be apparent to one of ordinary skill in the art in view of the drawings and specification. Moreover, it should be noted that the language used in the specification has been principally selected for readability and instructional purposes and may not have been selected to delineate or circumscribe the inventive subject matter.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 is a schematic of the system for plant growth disclosed herein; and

FIG. 2 is a schematic of an alternative embodiment of the system herein for plant growth disclosed.

### DETAILED DESCRIPTION OF THE INVENTION

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the application (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

By the term “autonomous” it is meant herein the quality or state of being self-governing and/or the system’s ability to both learn and independently make operational decisions as programmed and with substantially no human intervention or input.

The term “semi-autonomously” or “semi-autonomous” describes a system herein requiring partial human input or supervision for the operation of the plant growth herein.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention, unless specifically asserted herein.

Disclosed are components that can be used to perform the disclosed methods and systems. These and other components are disclosed herein, and it is understood that when combinations, subsets, interactions, groups, and the like of these components are disclosed that while specific reference of each various individual and collective combinations and permutation of these may not be explicitly disclosed, each is specifically contemplated and described herein, for all systems herein. This applies to all aspects of this application including, but not limited to, steps in disclosed systems and methods.

If there are a variety of additional steps that can be performed it is understood that each of these additional steps can be performed with any specific aspect or combination of aspects of the disclosed methods.

The invention herein provides a machine learning system for plant growth in a plant growing area. The system comprises a computer grade server (i.e., the server), a controller operatively connected to the computer grade server that has at least one central processing unit (i.e., CPU), non-transitory memory coupled to the at least one CPU, operating software by which to operate the controller, and a machine learning engine (i.e., the “MLE”).

The MLE herein comprises the steps of collecting data from multiple sensors placed about and within the plant growing area; forming a data set from the collected data; producing an estimate about a pattern in the data set; making a prediction about the data set; evaluating the prediction; and optimizing the prediction for accuracy.

Also, a relay board is operatively connected to the controller herein. More detail about the relay board’s functioning appears hereinbelow. The relay board herein controls multiple systems in use within the system; e.g., a plant watering system, a climate control system, a lighting system, a plant nutrient adjustment system and a pest control system.

The system has multiple sensors for monitoring plant growth placed about and within the plant growing area. The multiple sensors are operatively connected to the controller and feed data to the machine learning engine therein to form data sets by use of the MLE.

As part of the operation of the system herein, a system operator preferably has a personal wireless device which is in operative communication with the system for plant growth. The personal wireless device has a graphical interface (i.e., a touchscreen) for use by an operator whereby the operator communicates with the system to grow plants through said graphical interface. It should be noted herein that the operator’s personal wireless device performs functions which are similar or the same as that of the touchpad noted hereinabove. The goal of both the personal wireless device and the touchpad are to operate, maintain, and gain information from the system for plant growth.

The system herein provide user interfaces which are provided by the system’s touchpad and/or an application (i.e., “app”) operating upon the operator’s personal wireless device. The user interfaces are configured to allow users to review results of data for a selected sensor or detector, pinpoint relevant portions of data items where the selected sensor or detector is determined to be present, review and retrain detectors or sensors, specify example data items for training detectors or sensors, provide search result feedback, review data monitoring results and analytics, and the like.

The features and advantages described in the specification are not all inclusive and, in particular, many additional features and advantages will be apparent to one of ordinary skill in the art in view of the drawings and specification. Moreover, it should be noted that the language used in the specification has been principally selected for readability and instructional purposes and may not have been selected to delineate or circumscribe the inventive subject matter.

As has been noted hereinabove, this nonprovisional patent application claims priority to provisional patent application no. 63/323,505 which was filed on Aug. 25, 2022. It also incorporates by reference provisional patent application no. 63/391,722 filed on Jul. 23, 2022 and U.S. Pat. application no. 17/245,486 filed on Apr. 30, 2021.

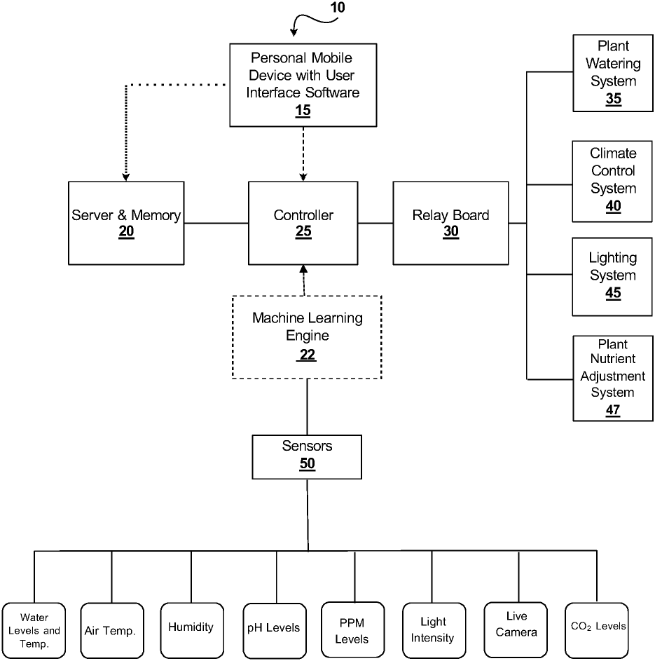

The invention as shown in FIG. 1 of the specification provides a schematic of the system for plant growth disclosed herein. It is a representation of the totality of one embodiment of system 10 as described herein. Shown are personal mobile device 15 also indicating the addition of the user interface software which enables a user (e.g., a farmer or plant grower) to operate system 10. The user interface software herein may be programmed in any suitable language for use onto personal mobile device like an IPHONE®, SAMSUNG®, ANDROID® and the like.

Also shown are server 20 (which contains non-transitory memory), controller 25 (which also contains non-transitory memory and machine learning engine 22), relay board 30, plant watering system 35, climate control systems 40, lighting systems 45, plant nutrient adjustment system 47 and sensors 50. More specifically, an array of sensors 50 is provided that are representative of the kinds of sensors useful within system 10.

A user’s personal mobile device 15 is used to interact with system 10 to direct it, maintain it and to learn from it. Personal mobile device 15 contains a software application (i.e., an “app”) that provides a usable graphical interface for operator use. In practice, the app enables a system operator (or “operator”) to interact with system 10, send instructions to it, pull data from it and make changes (i.e., executable commands) when and where necessary and/or desired. By use of the software, a user is able to remain in operative communication with server 20.

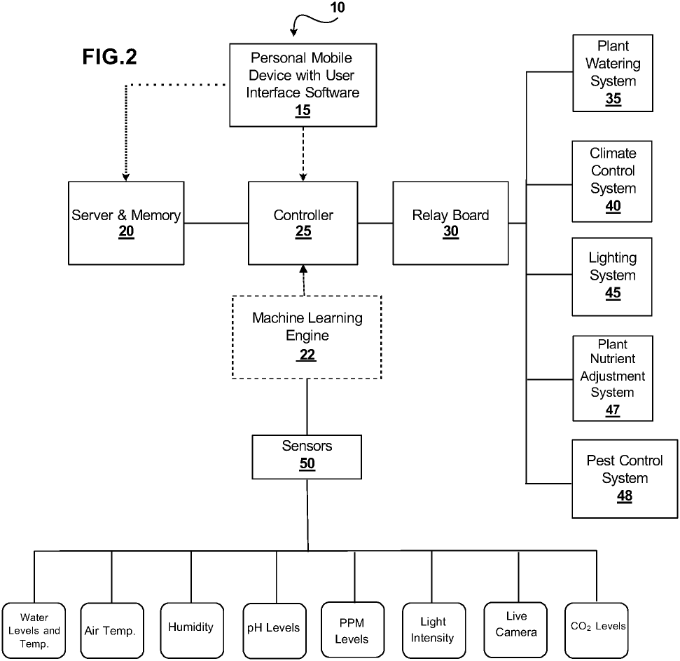

Controller 25 also comprises software, not necessarily graphical or operator accessible for direct manipulation, that receives and interprets instructions sent from personal mobile device 15 and then sends executable commands to the various within system 10 components (i.e., controller 25, relay board 30, and any one of the core plant growing system) of system 10. By the term “core plant growing system” it is meant herein one or more of the presence of any one of the major systems used for plant growth by the invention(s) herein including plant watering system 35, climate control system 40, lighting system 45, plant nutrient adjustment system 47 and pest control system 48 (FIG. 2).

Importantly, controller 25 also comprises, preferably, a substantial amount of memory. The memory of controller becomes critical to the effective operation of system 10 because, over time, the system accumulates many terabytes of data that enable a machine learning feature thereof. Since machine learning is highly data dependent, acquisition and storage thereof is paramount.

Server 20 provides a back-up to controller 25 and in particular adds additional memory for storage for data derived from sensors 50 or any one of the various systems 35, 40, 45, 47 or 48 operatively connected to controller 25.

FIG. 2 is a schematic of an alternative but related system herein for plant growth disclosed. It is a representation of the totality of system 10 as described herein. Shown are personal mobile device 15 also indicating the addition of the user interface software which enables a user or operator (e.g., a farmer) to operate system 10. Also shown are server 20, controller 25, relay board 30, climate control systems 40, lighting systems 45 and sensors 50. More specifically, an array of sensors 50 is provided which are representative of the kinds of sensors useful within system 10.

A user’s personal mobile device 15 is used to interact with system 10 to direct it and to learn from it. Personal mobile device 15 contains software with a usable graphical interface. This software allows a user to interact with system 10, send instructions to it, pull data from it and make changes (i.e., executable commands) where necessary. By use of the software, a user is able to remain in operative communication with server 20.

The alternative embodiment system 10 of FIG. 2 is the same as system 10 shown in FIG. 1 herein except that an additional core plant system has been added. The key add in FIG. 2 is the addition of pest control system 48. As part of the work done by plant growth system 10, controlling the kinds of pests attracted to plants grown within system 10 is paramount. This includes rodents, birds, insects and weeds. Pest control system 48 is preferably configured herein to limit or eliminate the presence of all manner of pests that would normally destroy growing plants within plant growing system 10.

The ideal pest control system 48 herein should be readily usable by system 10 and independently actuated by the system especially when it operates autonomously. Representative pest control systems herein include all of the following: GREENBUG SYSTEM FOR HOMEOWNERS; BLACK + DECKER BUG ZAPPER; AUTOMATED INSECT MONITORING (AIM); and SEMIOS MACHINE TO MACHINE (M2M) pest control systems.

For the embodiment disclosed in FIG. 2 herein, pest control system 48 is one of the important systems that is part of the core plant growing system. It is connected to relay board 30 as all of the other core plant growing systems hereinabove have been described to be a part of relay board 30.

The systems herein are provided with a user device also referred to herein as a “client device” or “personal mobile device”. The personal mobile device herein is a device having a computing system used by users (i.e., plant growers) to interact with the autonomous plant growth system or the semi-autonomous plant growth system. A user or plant grower interacts with the data related to the plant growth using a personal mobile device that executes client software, e.g., a web browser or a client application, to connect to the plant growth system.

The personal mobile device displayed in these embodiments can include, for example, a device like any one of the following: a laptop, a smart phone, or a tablet with operating systems such as ANDROID or APPLE IOS etc.), a desktop, wearable devices, a smart TV, and other network-capable devices.

Sensors herein include but are not limited to the following types: pH sensor, temperature sensor, humidity sensor, carbon dioxide sensor, pressure sensor, level sensor, and the like. Persons of skill in the art will be familiar with all of the various kinds of suitable sensors used for plant growth and/or farming and will also understand that choice of sensor forms no part of the invention herein.

In most or all instances herein, the sensors used by system 10 are all of the smart sensor variety. A smart sensor is a device that takes input from the physical environment and uses built-in computational resources to perform predefined functions upon detection of specific input and then process data before passing it on. Smart sensors enable more accurate and automated collection of environmental data with less erroneous noise amongst the accurately recorded information. These devices are used for monitoring and control mechanisms in a wide variety of environments including smart grids, battlefield reconnaissance, exploration and many science applications.

Smart sensors herein contain low-power mobile microprocessors. At a minimum, a smart sensor is made of a sensor, a microprocessor and communications hardware for transmission of either wireless and/or wired communications (i.e., data, location, and the like). The computer resources must be an integral part of the physical design. A typical sensor that merely collects and then transmits its data for remote processing is not considered a smart sensor of the kind contemplated herein.

A smart sensor herein may also include several other components besides the primary sensor. These components can include transducers, amplifiers, excitation control, analog filters and compensation. A smart sensor also incorporates software-defined elements that provide functions such as data conversion, digital processing and communication to external devices.

In practice, a smart sensor ties a raw base sensor to integrated computing resources that enable the sensor’s input to be processed. The base sensor is the component that provides the sensing capability. It can be designed to sense heat, light, humidity and/or pressure. Often, the base sensor will produce an analog signal that must be processed (e.g., digitized) before it can be used. This is where an intelligent sensor’s integrated technology comes into play. The onboard microprocessor filters out signal noise and converts the sensor’s signal into a usable, digital format.

Smart sensors of the kind used herein also contain integrated communications capabilities that enable them to connect to a private network or to the internet wired or wirelessly. Such connection ability would be programmed into the smart sensor itself and manipulable by an operator. This enables communication to external devices.

The preferred sensors herein are not base sensors. A base sensor is simply a sensor that isn’t equipped with a DMP or other computational resources that would enable it to process data. Whereas a smart sensor produces output that is ready to use, a base sensor’s output is raw and must typically be converted into a usable format, i.e., from analog to digital.

Smart sensors include an embedded Digital Motion Processor (DMP), whereas base sensors do not. A DMP is, essentially, a microprocessor that is integrated into the sensor. It enables the sensor to perform onboard processing of the sensor data. This might mean normalizing the data, filtering noise or performing other types of signal conditioning. In any case, a smart sensor performs data conversion digital processing prior to any communication to external devices.

Smart sensors are generally preferred over base sensors because they include native processing capabilities. Even so, there are situations where it might be more advantageous to use a base sensor or one or more base sensors in combination with the smart sensors herein.

Controller 25 herein is a device controller that handles the incoming and outgoing signals of server 20 as directed by the central processing unit (i.e., “CPU”) therein. Herein, controller 25 controls the signals sent to and the actions made by relay board 30, plant watering system 35, climate control system 40, lighting system 45, plant nutrient adjustment system 47 and all devices attached to and included therewith. Persons of skill in the art will readily recognize that all devices that are part of all of the aforementioned systems herein can be attached either by hard wire or wirelessly, the nature of said attachment not forming a part of the inventive system(s) herein. Each such device within the systems herein contain mechanical and electrical parts. In preferred practice, controller 25 uses binary and digital codes to communicate with each system, i.e., so-called ‘machine language’.

Controller 25 is a hardware unit operatively attached to the I/O bus of server 20 and works like an interface between a device and a device driver. It is an electronic device consisting of micro-chips that is responsible for handling the incoming and outgoing signals of the CPU.

Relay board 30 herein is an electronic computer powered boards with an array of relays and switches. They have input and output terminals and are designed to control the voltage supply of electricity flowing to attached devices, and specifically herein, all of the devices associated with plant water system 35, climate control system 40, lighting system 45 and plant nutrient adjustment system 47.

Relay boards of the kind used herein provide independently programmable, real-time control for each of several onboard relay channels. In practice, relays are the switches that close and open circuits electronically as well as electro-mechanically. It controls the opening and closing of the circuit contacts of one or more electronic circuits.

Each of the main systems herein (i.e., plant watering system 35, climate control system 40, lighting system 45 and plant nutrient adjustment system 47) comprise electronic circuitry and associated circuit contacts. Relay board 30 is operated by controller 25 from which all system 10 commands originate.

In but one example herein, controller 25 contains the necessary computer power (i.e., at least one CPU) to control all of the various systems within system 10. Controller 25 exports received data from sensors 50 for storage into one or more data sets that are usable and calculable by machine learning engine 22.

Importantly, the systems and methods herein preferably use machine learning to treat, analyze and make predictions upon its collected data. Machine learning (ML) involves the use and development of computer systems that are able to learn and adapt without direct human intervention, by using algorithms and statistical models to analyze and draw inferences from patterns in data and then make choices thereby.

Machine learning is a branch of artificial intelligence (AI) and computer science that focuses on the use of data and algorithms to imitate the way that humans learn, gradually improving its accuracy. Machine learning is an important component of the growing field of data science. Through the use of statistical methods, algorithms are trained to make classifications or predictions, uncovering key insights within data mining projects.

The critical, key elements of machine learning analysis are all of the following: data set; one or more algorithms; data models; feature extraction (as applied to the data); and training of a system in which machine learning is applied.

The term “data set” is defined herein as a collection of data pieces that can be treated by a computer as a single unit for analytic and prediction purposes. The term “algorithm” as used herein is defined as a mathematical or logical program that turns a data set into a model. The term “model” or “models” as used herein is defined as a computational representation of real-world processes. The term “feature extraction” as used herein means a process of transforming raw data into numerical features that can be processed while preserving the information in the original data set. The term “training” as used herein means one or more approaches that allow machine learning models to identify patterns and make decisions.

In practice, machine learning comprises three main functions: 1) a decision process; 2) an error function; and 3) a model optimization process. In general, machine learning algorithms are used to make a prediction or classification. Based on some input data, which can be labelled or unlabeled, your algorithm will produce an estimate about a pattern in the data. An error function serves to evaluate the prediction of the model. If there are known examples, an error function can make a comparison to assess the accuracy of the model. If the model can fit better to the data points in the training set, then weights are adjusted to reduce the discrepancy between the known example and the model estimate. The algorithm will repeat this evaluative and optimization process, updating weights autonomously until a threshold of accuracy has been met.

Herein, a machine learning engine is provided that provides all of the following steps:
1. Collecting data from the multiple sensors;
2. Forming a data set from the collected data;
3. Producing an estimate about a pattern in the data set;
4. Making a prediction about the data set;
5. Evaluating the prediction; and then
6. Optimizing the prediction for accuracy of overall system operation.

The collected data comes from any one of the provided sensors 50 shown in FIG. 1, some of them or all of them. Sensors 50 are in place to monitor all plant growth within system 10 continuously. Data from sensors 50 is placed into data sets usable by machine learning engine 22.

In practice, machine learning engine 22 resides within the non-transitory memory of controller 25. In FIG. 1, machine learning engine 22 is shown in its own box with a dotted line to the server and memory box. It is shown in this manner to individualize the presence and existence of machine learning engine 22, but persons of skill in the art will readily understand that machine learning engine 22 is not a stand-alone device that exists outside the immediate purview of computer grade server 20 nor its non-transitory memory.

Sensors 50 are also shown to be connected to machine learning engine 22 (which is to say controller 25). In practice, raw data flows from sensors 50 into the non-transitory memory housed within controller 25 and is then treated and segregated by machine learning engine 22. Once the raw data from sensors 50 is collected, machine learning engine 22 then goes about the business of producing an estimate about a pattern in the data set. In other words, machine learning engine 22 looks for patterns in the raw data and logs them.

At the production of the estimate, machine learning engine 22 makes one or multiple predictions about the trend of the data in order to adjust or otherwise manipulate plant watering system 35, climate control system 40, lighting system 45, plant nutrient adjustment system 47 and/or pest control system 48.

Once an estimate is produced, for example existing water levels as compared to a known norm in water levels, system 10 can then calculate appropriate remedial action, if necessary, based upon a calculated prediction (i.e., that is at least partially reliant on historical data acquisition stored in one or more databases for reference by machine learning engine 22) of where water levels will trend given a) no action to remediate and/or b) appropriate action to remediate an existing deficit.

Before the prediction is relied upon to execute action by system 10, it can be evaluated by machine learning engine 22. Methods of evaluation are statistical and can include classification accuracy, logarithmic loss, confusion matrix, area under curve, F1 score, mean absolute error, and mean squared error.

Classification accuracy is what is usually meant by the term “accuracy”. It is the ratio of number of correct predictions to the total number of input samples. Log-loss is indicative of how close the prediction probability is to the corresponding actual/true value (0 or 1 in case of binary classification). The more the predicted probability diverges from the actual value, the higher is the log-loss value. A confusion matrix is a table that is used to define the performance of a classification algorithm. A confusion matrix visualizes and summarizes the performance of a classification algorithm.

Area Under Curve (AUC) is one of the most widely used metrics for evaluation. It is used for binary classification problem. AUC of a classifier is equal to the probability that the classifier will rank a randomly chosen positive example higher than a randomly chosen negative example. F1 Score is the Harmonic Mean between precision and recall. The range for F1 Score is [0, 1]. It tells one how precise a known classifier is (i.e., how many instances it classifies correctly), as well as how robust it is. To be clear, it does not miss a significant number of instances. Mean absolute error is the average of the difference between the original values and the predicted values. It provides the measure of how far the predictions are from the actual output. However, they do not provide any idea of the direction of the error, i.e., whether the system (i.e., the machine learning engine) either under or over predicts the data.

Once all predictions for all measurables (e.g., water level, nutrient level, lighting levels, temperature, humidity, and the like) have been evaluated, the next step is to optimize the predictions for use. The term “prediction” herein refers to the output of an algorithm after it has been trained on a historical dataset and applied to new data when forecasting the likelihood of a particular outcome.

System 10 herein may operate autonomously meaning that the system self-adjusts and executes commands without human intervention. System 10′s self-adjustment derives from optimization of the prediction(s) created by machine learning engine 22. At optimization of the prediction(s) for accuracy, system 10 next produces one or more commands for adjustment to system 10; i.e., plant watering system 35, climate control system 40, lighting system 45 and/or plant nutrient adjustment system 47. Ideally, system 10 is both self-governing and self-actuating.

By the term “self-governing” it is meant herein that system 10 can continuously evaluate its performance and monitor itself and also issuing commands (or make recommendations) to one or more inherent systems (e.g., lighting system 45) for action, correction, maintenance, etc.

By the term “self-actuating” it is meant herein that system 10 can itself execute commands generated from its calculated optimized predictions.

The intent of an autonomous system 10 herein is that it operate substantially without human hands or intervention. More specifically, plant watering system 35, climate control system 40, lighting system 45 and plant nutrient system 47 are meant, in a fully autonomous system 10, to be controlled and operable solely by controller 25. This level of autonomous operability is especially important for large scale farming in which many other functions are also automated including harvesting machines, fruit pickers and the like. It is also important in farming and/or plant growing conditions in which human labor is sparse or not existent except for the minimal handling and maintenance of system 10.

In practice, the minimal handling and maintenance of system 10 requires a qualified person or persons to maintain or repair each of the critical plant growth systems (i.e., plant watering system 35, climate control system 40, lighting system 45 and plant nutrient adjustment system 47) for example, ensuring that an ample water supply is provided, adequate plant nutrients fill the system therefor, and the like. If one of the critical systems that make up system 10 breaks, one or more humans is expected to repair it. If controller 25 goes off -line, a human operator must see about it and provide remedy.

System 10 may also operate semi-autonomously. Semi-autonomous operation of system 10 herein means that the system self-adjusts and executes commands without human intervention. System 10′s self-adjustment derives from optimization of the prediction(s) created by machine learning engine 22. At optimization of the prediction(s) for accuracy, system 10 next produces one or more commands for adjustment to system 10; i.e., plant watering system 35, climate control system 40, lighting system 45 and/or plant nutrient adjustment system 47. Ideally, system 10 is at least partially self-governing but not self-actuating. By self-governing it is meant that system 10 can continuously evaluate itself and issue commands (or make recommendations) for action. By self-actuating it is meant herein that system 10 can itself execute commands generated from its calculated optimized predictions but in the instance in which system 10 is semi-autonomous, one or more human operators execute command recommendations created proffered by machine learning engine 22.

The intent of a semi-autonomous system 10 herein is that it operates partially without human hands or intervention. More specifically, plant watering system 35, climate control system 40, lighting system 45 and plant nutrient system 47 are meant, in a semi-autonomous system 10, to be only partially controlled and operable by controller 25 but also controlled and manipulated by human hands (i.e., human workers/operators).

Importantly, the degree of semi-autonomy of system 10 can be adjusted. Once recommendations for action are provided by machine learning engine 22, human operators can then decide to what degree or another to execute those recommendations. For example, with machine learning engine recommendations in hand, human operators can choose to personally manage each of the major systems herein (i.e., plant watering system 35, climate control system 40, lighting system 45 and/or plant nutrient adjustment system 47), one of them or fewer than all four of them. Regardless of the choice of degree of semi-autonomy of system 10, any human operator manipulation of one or more of the major systems causes system 10 herein to be semi-autonomous.

In one embodiment, the detectors or sensors are configured to analyze plants can be trained using a machine learned model. A detector can detect a predetermined set of visual features of the plants and provide the analysis to a user for decision making.

In one embodiment, the detectors can also be a machine created software based detectors wherein the detectors identify the requirements of the system or the user and provide data accordingly. The system, through machine learning, trains and manages detectors. By use of machine learning, the system is self-learning. A detector can be configured to search for a particular set of data items. In various embodiments, the system creates the detectors by training one or more machine learning models using training data. The training data include example data items provided by a user. The training data can include positive examples and/or negative examples. A positive example includes desired features and the negative example includes undesired characteristics.

The system has the ability to autonomously or semi-autonomously self-adjust it choice(s) based upon past and current plant growth performance and/or criteria irrespective. In practice, the system tracks and records all data generated from the various sensors and monitors and other gathered historical data all of which information is stored to memory in one or more computer grade servers. The system can then reference the historical data for future evaluation of optimal plant growth by the system.

A user can manage, control and automate farming operations using client’s software positioned onto the CPU (or microcontroller) of personal mobile deice 15. As part of its autonomous operation, system 15 may further comprise an autopilot feature by which system 10 is self-governing.

In another embodiment herein, system 10 may also include one or more cameras to visually monitor system operations and plant growth. Images taken by cameras attached to system 10 are transferred, preferably but not necessarily wirelessly, to controller 25 or server 20. Those images are then subject to machine learning engine 22 for treatment, identification and further storage. Once treated, the images are accessible by personal mobile device 15 through controller 25. The images may be viewable in real time and of course, in times subsequent to their acquisition. An operator of system 10 may have as many or as few cameras positioned about and within a plant growing area in which system 10 resides, the number of cameras used forming no part of the invention herein.

In all embodiments herein, machine learning 22 examines, classifies, organizes, categorizes, treats and creates executable commands from all data acquired by system 10, most notably from sensors 50. the client’s software can classify portions of data using machine-learning detectors and modify user interface elements based on the classification. System 10 can categorize plant growth stages based on live feedback obtained from sensors 50 fed to machine learning engine 22 via server 20.

In one embodiment, the user interface elements are updated based on the data selected by the user. The sensors 50 are trainable using machine learning techniques provided by machine learning engine 22 to identify the changes in the plant growth in various stages and alert or notify a user through the client’s software housed on personal mobile device 15.

In another embodiment herein, a user can program the entire plants growth process to be fully or partially autonomous by creating schedules for lighting, climate, nutrient dosing, watering, pest control and more. System 15 can control the sensors, all major core systems herein and/or machinery within system 10.

In one embodiment, a user can select or remove one or more sensors, and/or core systems herein (e.g., plant watering system 35, climate control system 40, etc.) for close inspection or manipulation. In practice, all aspects of system 10 may be wirelessly connected to the Internet through LAN, WAN or wireless network. System 10 may also be updated and the user can download specific nutrient recipes for crops and save program for precision and crop consistency.

In practice of system 10 herein, controller 25 (or server 20) may reference a plant profile for parameters inputted (by a user) into system 10 based on a plant’s stage of life. System 10 may take pictures of one or more plants growing therein and use image processing software to determine its stage of life as determined by machine learning engine 22. The system can automatically refill water and nutrients to the plants based on the data received from sensors 50.

In another embodiment, the system can communicate with a user through one or more interfaces such as a graphical user interface via the client’s software, audio and/or visual signals (e.g., lights and/or sound) through one or more peripherals, and the like.

In another aspect of system 10′s practice, system 10 maintains a log record wherein various events are recorded. The log record is updated in real time and is synchronized, in real time, with the client’s software at the personal mobile device 15.

In one embodiment, the detectors or sensors includes but not limited to temperature sensors, climate sensors, cameras, humidity sensors, motion detection, air, nutrient levels, pH level, CO² levels, and the like as shown in both FIGS. 1 and 2.

In one embodiment, a user can control various components of the system like valves, lights, pumps, motors, air system and other sensors. The valves includes but are not limited to water valve, drain valve, and the like. The pumps include but are not limited to an ozone pump, dosing pump, water pump, and more. The air system may include one or more of the following: air conditioning unit(s), circulating fan(s), intake fan(s), exhaust fan(s), dehumidifier(s), ozone generator(s) or combinations thereof.

Variations on preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

It should be appreciated and understood that the present invention may be embodied as systems, methods, apparatus, computer readable media, non-transitory computer readable media and/or computer program products. The present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” The present invention may take the form of a computer program product embodied in one or more computer readable medium(s) having computer readable program code embodied thereon.

One or more computer readable medium(s) may be utilized, alone or in combination. The computer readable medium may be a computer readable storage medium or a computer readable signal medium. A suitable computer readable storage medium may be, for example, but not limited to, an electronic, magnetic, optical, electromagnetic, infrared, or semiconductor system, apparatus, or device, or any suitable combination of the foregoing. Other examples of suitable computer readable storage medium include, without limitation, the following: an electrical connection having one or more wires, a portable computer diskette, a hard disk, a random access memory (RAM), a read-only memory (ROM), an erasable programmable read only memory (EPROM or flash memory), an optical fiber, an optical storage device, a magnetic storage device, or any suitable combination of the foregoing. A suitable computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Python, C++ or the like and conventional procedural programming languages, such as the “C” programming language or similar programming languages. The program code may execute entirely on the user’s computing device ( such as, a computer), partly on the user’s computing device, as a stand-alone software package, partly on the user’s computing device and partly on a remote computing device or entirely on the remote computing device or server. In the latter scenario, the remote computing device may be connected to the user’s computing device through any type of network, including a local area network (LAN) or a wide area network (WAN), or the connection may be made to an external computing device (for example, through the Internet using an Internet Service Provider).

The present invention is described herein with reference to flowchart illustrations and/or block diagrams, can be implemented by computer program instructions. These computer program instructions may be provided to a processor of a general purpose computing device (such as, a computer), special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computer program instructions may also be stored in a computer readable medium that can direct a computing device, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions/acts specified in the flowchart and/or block diagram block or blocks.

It should be appreciated that the function blocks or modules shown in the drawings illustrate the architecture, functionality, and operation of possible implementations of systems, methods and computer program media and/or products according to various embodiments of the present invention. In this regard, each block in the drawings may represent a module, segment, or portion of code, which comprises one or more executable instructions for implementing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order, depending upon the functionality involved.

It will also be noted that each block and combinations of blocks in any one of the drawings can be implemented by special purpose hardware-based systems that perform the specified functions or acts, or combinations of special purpose hardware and computer instructions. Also, although communication between function blocks or modules may be indicated in one direction on the drawings, such communication may also be in both directions.

The present invention may be embodied in other specific forms without departing from its spirit or essential characteristics. The described embodiments are to be considered in all respects only as illustrative and not restrictive. The scope of the invention is, therefore, indicated by appended claims rather than by the foregoing description. All changes which come within the meaning and range of equivalency of the claims are to be embraced within their scope. The written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for plant growth, comprising:
a. A plant growing area;
b. Multiple plant growth sensors positioned within said plant growing area;
c. A computer grade server having memory:
d. A controller operably connected to said computer grade server, comprising;
i. At least one central processing unit;
ii. Non-transitory memory coupled to said at least one processor;
iii. Operating software by which to operate said computer grade server;
iv. A machine learning engine algorithm providing the steps of
1. Collecting data from said multiple plant growth sensors;
2. Forming a data set from said collected data;
3. Producing an estimate about a pattern in said data set;
4. Making a prediction about the data set;
5. Evaluating said prediction;
6. Optimizing the prediction for accuracy;
e. A relay board operatively connected to said controller;
f. A plant watering system positioned about said plant growing area, said plant watering system being operatively connected to said relay board;
g. A climate control system positioned about said plant growing area, said climate control system being operatively connected to said relay board;
h. A lighting system positioned about said plant growing area, said lighting system being operatively connected to said relay board;
i. A plant nutrient delivery system positioned about said plant growing area, said plant nutrient delivery system being operatively connected to said relay board; and
j. A personal wireless device having a graphical interface for use by a user wherein said personal wireless device is in operative communication with said system to grow plants through said graphical interface.

2. The system of claim 1 wherein said personal wireless device provides ideal criteria for plant growth.

3. The system of claim 2 wherein a user uses said personal wireless device to manipulate said plant watering system, said climate control system and said lighting system.

4. The system of claim 3 wherein said personal wireless device provides data from said multiple sensors through said graphical interface to a user.

5. The system of claim 1 wherein said optimized prediction from said machine learning engine is usable by said system to autonomously alter parameters for output of said plant watering system, said climate control system and said lighting system.

6. The system of claim 1 wherein said optimized prediction from said machine learning engine is usable by said system to semi-autonomously alter parameters for output of said plant watering system, said climate control system and said lighting system.

7. The system of claim 1 further comprising a pest control system, said pest control system being operatively connected to said relay board.
